(19) United States
(12) Patent Application Publication
(10) Pub. No.: US 2012/0326063 A1
(43) Pub. Date: Dec. 27, 2012

(54) WATER CONTROL CERAMIC VALVE WITH LOWER CERAMIC CHIP HAVING LIMITATION FUNCTIONS

(75) Inventor: Mei-Li CHEN, Tanzih Township (TW)

(73) Assignee: KUCHING INTERNATIONAL LTD., Tanzih Township (TW)

(21) Appl. No.: 13/169,346

(22) Filed: Jun. 27, 2011

(51) Int. Cl. F16K 31/02

(52) U.S. Cl. 251/129.01

(57) ABSTRACT

A water control ceramic valve with a lower ceramic chip having limitation functions includes a shell, pedestal, lower ceramic chip, upper ceramic chip, control panel, bearing and brake rod. The lower ceramic chip is assembled directionally over the pedestal, and sealed by the water-stop ring. The top end of the lower ceramic chip is provided with a flat surface. Two water channels and a discharge guide hole are set on the lower ceramic chip correspondingly to two water inlets and a water outlet of the pedestal. A lower ceramic chip spacing ring is positioned securely between the bottom opening of the shell and the pedestal. The spacing ring has a ring wall and limiting flanges protruded from the inner side of the ring wall. The ring wall can be interfaced with the bottom opening of the shell and top surface of the pedestal.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a water control ceramic valve, and more particularly to an innovative one which is designed with a lower ceramic chip having limitation functions.

2. Description of Related Art Including Information Disclosed Under 37 CFR 1.97 and 37 CFR 1.98.

The water control ceramic valve is structurally designed in a way that a control panel is generally assembled into the inner end of the brake rod, and then set onto an upper ceramic chip. The upper ceramic chip is attached slidably onto a lower ceramic chip, which is mounted directionally over a pedestal. The pedestal is assembled at shell bottom of the water control ceramic valve, so that the control panel, upper and lower ceramic chips are limited between the shell's top wall and pedestal.

The bottom diameter of the hot/cold water inlets of said lower ceramic chip is generally designed to be the same as the diameter of the hot/cold water inlets of the pedestal. Yet, in response to the water inlets of the lower ceramic chip with different diameters, bigger hot/cold water inlets of the pedestal are designed, but downward bevelled bottom of the hot/cold water inlets of said lower ceramic chip is designed to be fitted with the hot/cold water inlets of the pedestal. Meanwhile, the top of the hot/cold water inlets of said lower ceramic chip with different diameters can be designed. Hence, the lower ceramic chips with different diameters can be used on the same pedestal to save the molding cost.

However, the following shortcomings are observed during actual applications:

When the conventional water control ceramic valve charged with water is used, the water pressure is guided from the pedestal to the upper ceramic chip via the lower ceramic chip. As the bottom of the hot/cold water inlets of the lower ceramic chip is designed into a bevelled pattern, the pressure is boosted due to reduction of sectional area when water flows upwards. With a pushing force generated by the pressure, the lower ceramic chip is pulled upwards. This will lead to the loosening of the sealing point of the water-stop ring that is set on the pedestal by abutting the bottom of the lower ceramic chip, thus resulting in serious water leakage. In particular, when the water-stop ring is hardened after a period of time, said water leakage will occur in advance, leading to dramatic reduction of the service life of the water control ceramic valve.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

Based on the unique design of the present invention wherein “the water control ceramic valve with lower ceramic chip having limitation functions” allows said lower ceramic chip spacing ring to be positioned securely between the bottom opening of the shell and the pedestal, the limiting flange of the lower ceramic chip spacing ring could be used to limit and position stably the lower ceramic chip, thus preventing efficiently the loosening of lower ceramic chip under water pressure. This could avoid water leakage, extend the service life and improve the quality of the water control ceramic valve with better applicability and industrial benefits.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is an assembled perspective view of the preferred embodiment of the water control ceramic valve of the present invention.

FIG. 2 is an exploded perspective view of the preferred embodiment of the water control ceramic valve of the present invention.

FIG. 3 is an exploded sectional view of the preferred embodiment of the water control ceramic valve of the present invention.

FIG. 4 is another lateral assembled sectional view of the water control ceramic valve of the present invention.

FIG. 5 is a schematic view of the first assembly process view of the water control ceramic valve of the present invention.

FIG. 6 is a schematic view of the second assembly process view of the water control ceramic valve of the present invention.

FIG. 7 is a schematic view of the third assembly process view of the water control ceramic valve of the present invention.

FIG. 8 is an assembled sectional view of the water control ceramic valve of the present invention.

### DETAILED DESCRIPTION OF THE INVENTION

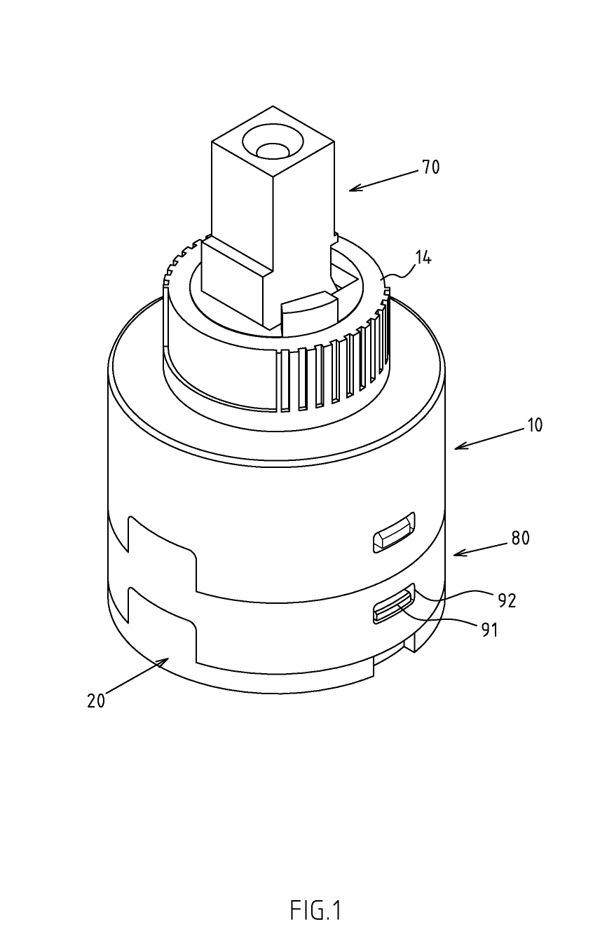

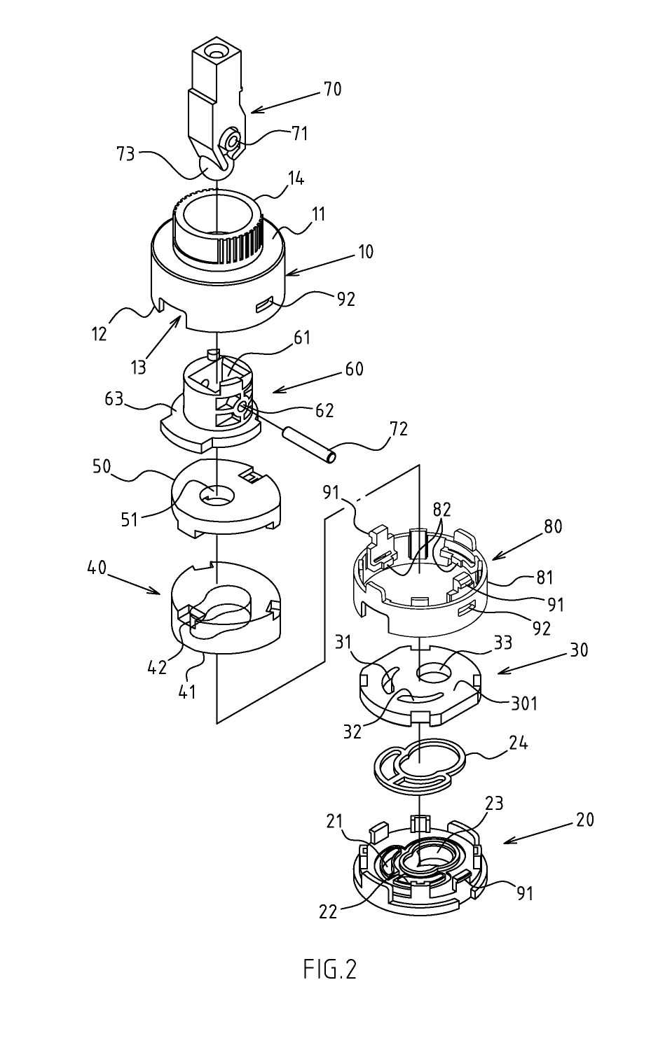

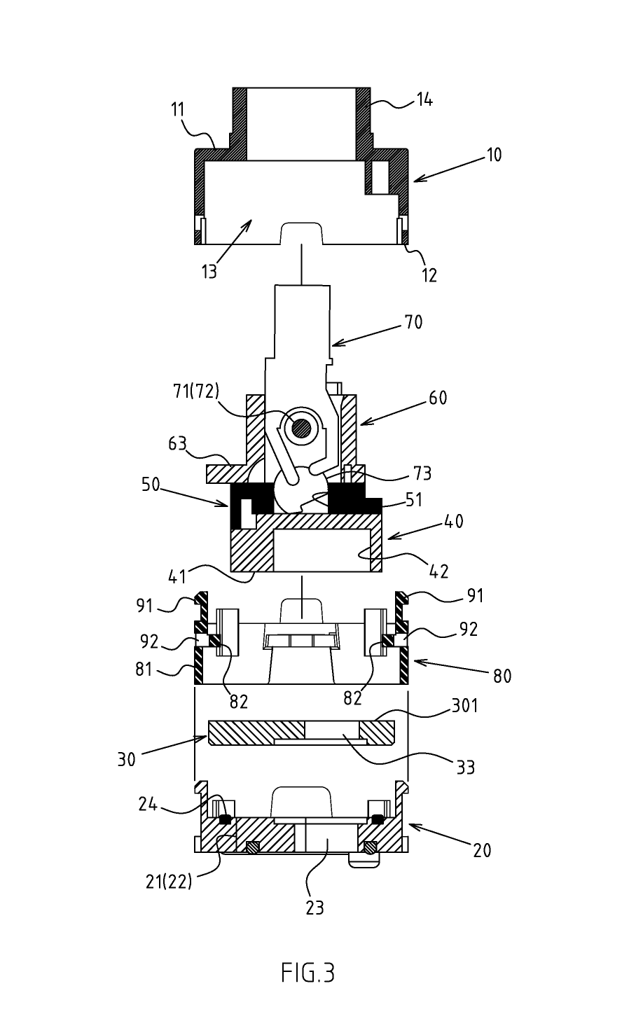

FIGS. 1-4 depict preferred embodiments of a water control ceramic valve of the present invention with a lower ceramic chip having limitation functions, which, however, are provided for only explanatory purpose for patent claims. Said water control ceramic valve comprises a shell 10, comprising of a top end 11, a bottom opening 12 and an internal hollow chamber 13. The top end 11 is provided with a reduced nozzle 14;

A pedestal 20 is set below the bottom opening 12 of the shell 10, and provided with two water inlets 21, 22 (i.e. hot/cold water inlets) and a water outlet 23. A water-stop ring 24 is set on the top surface of the pedestal 20.

A lower ceramic chip 30 is assembled directionally over the pedestal 20, and sealed by the water-stop ring 24. The top end of the lower ceramic chip 30 is provided with a flat surface 301. Two through-type water channels 31, 32 and a discharge guide hole 33 are set on the lower ceramic chip 30 correspondingly to two water inlets 21, 22 and a water outlet 23 of the pedestal 20.

An upper ceramic chip 40 is set slidably over the lower ceramic chip 30. The bottom of the upper ceramic chip 40 is provided with a sliding surface 41 that can be tightly abutted on the flat surface 301 of the top end of the lower ceramic chip 30. Moreover, a collection tray 42 is recessed into the sliding surface 41 of the upper ceramic chip 40 correspondingly to the discharge guide hole 33 of the lower ceramic chip 30. The collection tray 42 is spanned to two water channels 31, 32 of the lower ceramic chip 30 with the sliding shift of the upper ceramic chip 40.

A control panel 50 is assembled directionally over the upper ceramic chip 40, and used to drive the upper ceramic chip 40. A toggling trough 51 is set on the top end of the control panel 50.

A bearing 60 is set into the nozzle 14 at top end of the shell 10. An assembly port 61 vertically penetrates the center of the bearing 60. A setting hole 62 is set transversely on the middle section of the assembly port 61, while a limiting ring plate 63 is set at bottom of the bearing 60.

A brake rod 70 is set perforatively into the assembly port 61 of the bearing 60. The tip of the brake rod 70 is protruded out of the nozzle 14 of the shell 10, allowing for assembly of the preset faucet handle. An axle hole 71 is set at middle section of the brake rod 70, enabling to set into the setting hole 62 of the bearing 60 via a bolt rod 72. Hence, the brake rod 70 swings by taking the bolt rod 72 as a pivot. The bottom of the brake rod 70 is provided with a toggling portion 73 for inserting into the toggling trough 51 at top end of the control panel 50. Hence, the control panel 50 can be driven by the brake rod 70 to control the state of water discharge (including opening/closing and water temperature control).

A lower ceramic chip spacing ring 80 is positioned securely between the bottom opening 12 of the shell 10 and the pedestal 20. The lower ceramic chip spacing ring 80 comprises of a ring wall 81 and limiting flanges 82 protruded from inner side of the ring wall 81. Of which, the ring wall 81 can be interfaced with the bottom opening 12 of the shell 10 and top surface of the pedestal 20. The height and location of the limiting flange 82 allows to be abutted onto the flat surface 301 of the lower ceramic chip 30.

Of which, the ring wall 81 of the lower ceramic chip spacing ring 80, the shell 10 and pedestal 20 can be assembled securely via a plurality of interlocking hooks 91 and locating holes 92.

Of which, a plurality of limiting flanges 82 of the lower ceramic chip spacing ring 80 can be protruded at interval from inner side of the ring wall 81, or alternatively designed into an annular pattern.

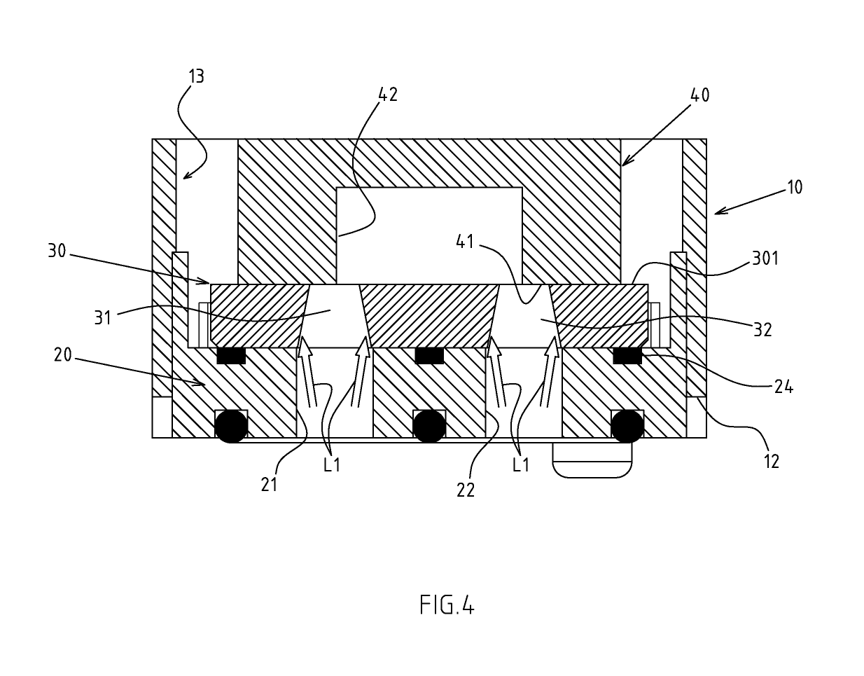

Based on above-specified structural configuration, the core aspect and functionality of the present invention lie in that, when the water control ceramic valve is completely assembled, the limiting flange 82 of the lower ceramic chip spacing ring 80 is used to limit and position stably the lower ceramic chip 30, thus preventing efficiently the loosening of lower ceramic chip 30 under water pressure. Said water pressure refers to the pressure applied upwards by two water inlets 21, 22 of the pedestal 20 to two water channels 31, 32 of the lower ceramic chip 30 (marked by arrow L1 in FIG. 4).

Furthermore, the water control ceramic valve of the present invention is assembled in a unique sequence via arrangement of the lower ceramic chip spacing ring 80. The features of the present invention are described with reference to the accompanying drawings:

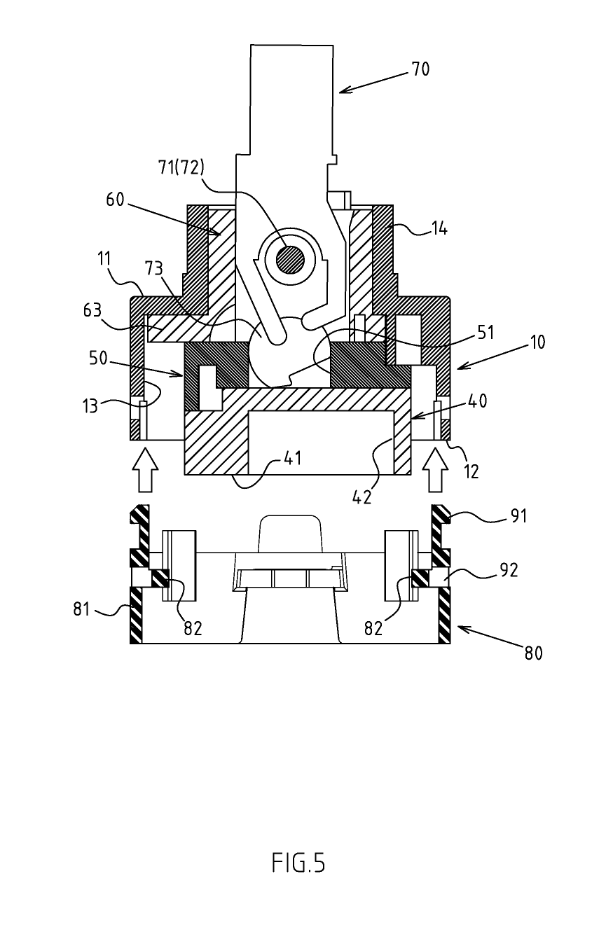

Referring to FIG. 5, after the brake rod 70, bearing 60 and control panel 50 are assembled together, the bearing 60 is set into the nozzle 14 at top end of the shell 10 from the bottom opening 12, and next the upper ceramic chip 40 is mounted directionally at bottom of the control panel 50.

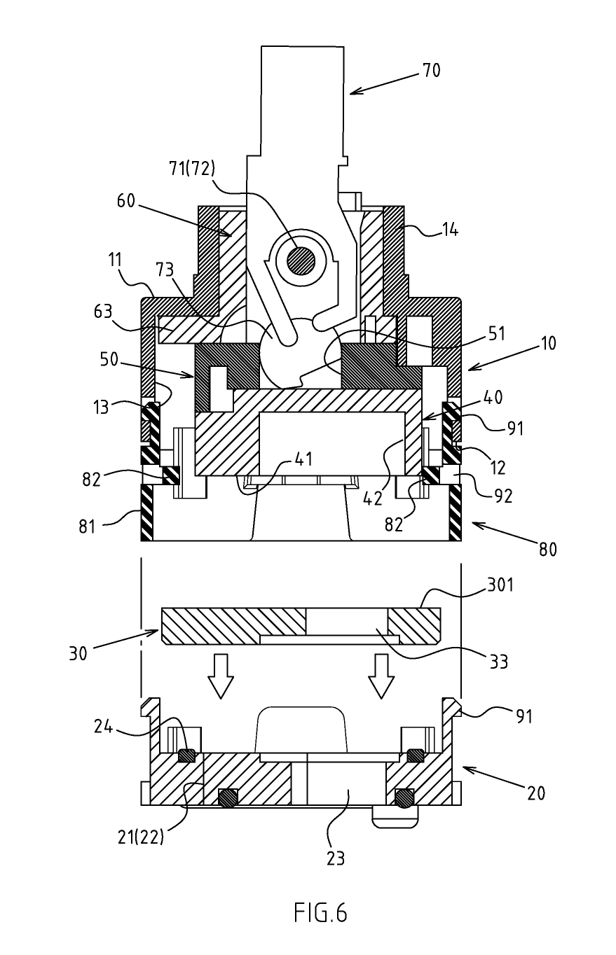

Referring to FIG. 6, the lower ceramic chip spacing ring 80 is assembled securely onto the bottom opening 12 of the shell 10. On the other hand, the lower ceramic chip 30 is mounted directionally over the pedestal 20.

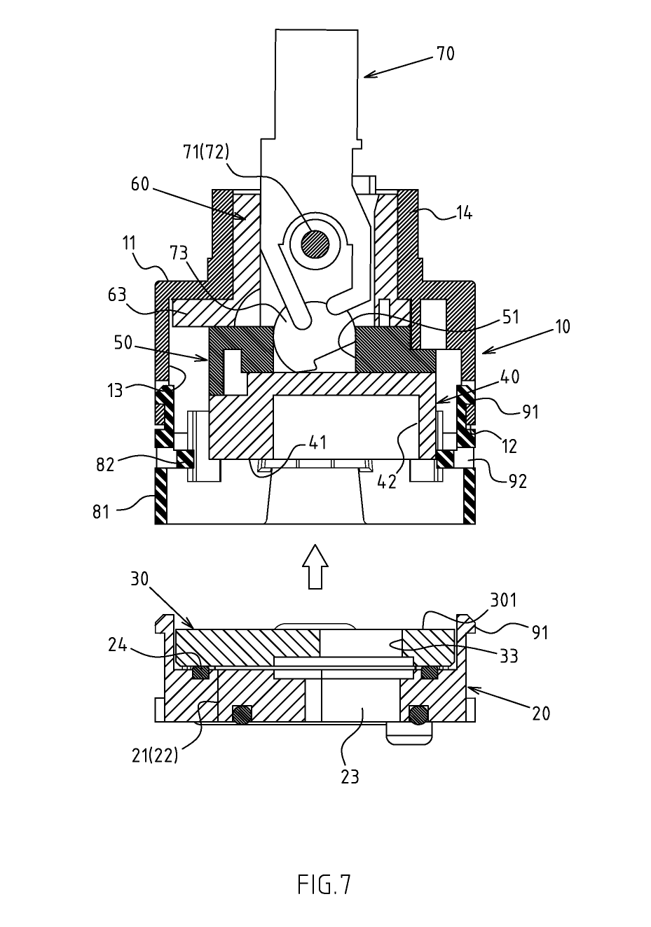

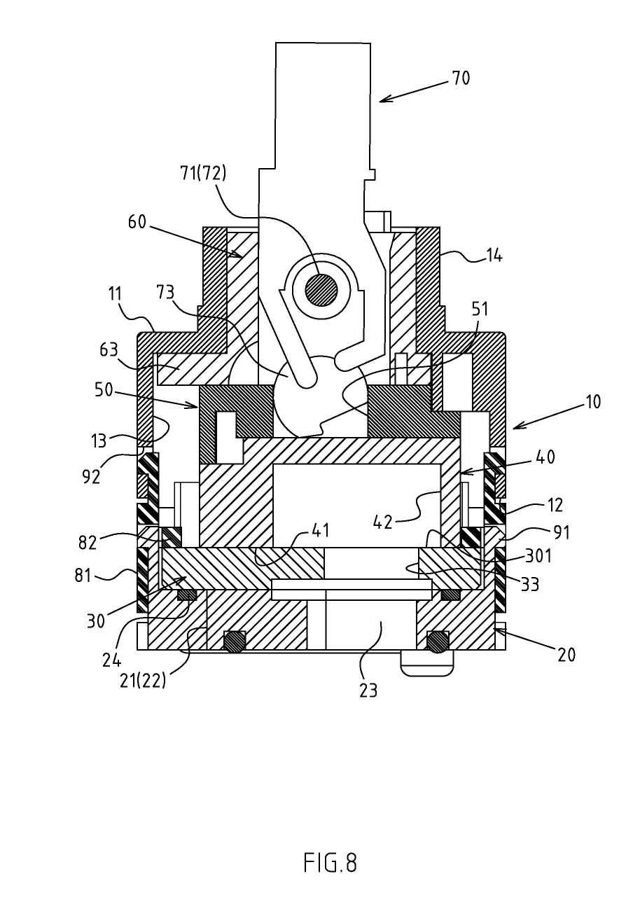

Referring to FIGS. 7 and 8, the pedestal 20 is assembled onto the bottom of the lower ceramic chip spacing ring 80, meanwhile the lower ceramic chip 30 is assembled into the ring wall 81 of the lower ceramic chip spacing ring 80, and the flat surface 301 of the lower ceramic chip 30 is abutted onto the limiting flange 82 of the lower ceramic chip spacing ring 80, such that the lower ceramic chip 30 is limited.

1. A water control ceramic valve with a lower ceramic chip having limitation functions comprising:
a shell; comprising of a top end, a bottom opening and an internal hollow chamber; the top end is provided with a reduced nozzle;
a pedestal; set below the bottom opening of the shell, and provided with two water inlets and a water outlet; a water-stop ring is set on the top surface of the pedestal;
a lower ceramic chip assembled directionally over the pedestal, and sealed by the water-stop ring; the top end of the lower ceramic chip is provided with a flat surface; and, two through-type water channels and a discharge guide hole are set on the lower ceramic chip correspondingly to two water inlets and a water outlet of the pedestal;
an upper ceramic chip set slidably over the lower ceramic chip; the bottom of the upper ceramic chip is provided with a sliding surface that can be tightly abutted on the flat surface of the top end of the lower ceramic chip; moreover, a collection tray is recessed into the sliding surface of the upper ceramic chip correspondingly to the discharge guide hole of the lower ceramic chip; the collection tray is spanned to the water channels of the lower ceramic chip with the sliding shift of the upper ceramic chip;
a control panel assembled directionally over the upper ceramic chip, and used to drive the upper ceramic chip; a toggling trough is set on the top end of the control panel;
a bearing set into the nozzle at top end of the shell; an assembly port vertically penetrates the center of the bearing; a setting hole is set transversely on the middle section of the assembly port, while a limiting ring plate is set at bottom of the bearing;
a brake rod set perforatively into the assembly port of the bearing; the tip of the brake rod is protruded out of the nozzle of the shell, allowing for assembly of the preset faucet handle; an axle hole is set at middle section of the brake rod, enabling to set into the setting hole of the bearing via a bolt rod; hence, the brake rod swings by taking the bolt rod as a pivot; the bottom of the brake rod is provided with a toggling portion for inserting into the toggling trough at top end of the control panel; hence, the control panel can be driven by the brake rod;
a lower ceramic chip spacing ring, positioned securely between the bottom opening of the shell and the pedestal; the lower ceramic chip spacing ring comprises of a ring wall and limiting flanges protruded from inner side of the ring wall; of which the ring wall can be interfaced with the bottom opening of the shell and top surface of the pedestal; the height and location of the limiting flange allows to be abutted onto the flat surface of the lower ceramic chip;
the limiting flange of the lower ceramic chip spacing ring is used to limit and position stably the lower ceramic chip, thus preventing efficiently the loosening of lower ceramic chip under water pressure.

2. The structure defined in claim 1, wherein the ring wall of the lower ceramic chip spacing ring, the shell and pedestal can be assembled securely via a plurality of interlocking hooks and locating holes.

3. The structure defined in claim 1, wherein a plurality of limiting flanges of the lower ceramic chip spacing ring can be protruded at interval from inner side of the ring wall.
